(19) United States
(12) Patent Application Publication
(10) Pub. No.: US 2004/0111288 A1
(43) Pub. Date: Jun. 10, 2004

(54) System and method for querying reports using a mobile computing device

(76) Inventors: Hsueh Yin Lee, Taipei (TW); Hui Zhen Huang, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/643,553

(22) Filed: Aug. 18, 2003

(30) Foreign Application Priority Data
Dec. 10, 2002 (TW) 91135753

(51) Int. Cl. G06F 17/60

(52) U.S. Cl. 705/1

(57) ABSTRACT

A system for querying reports using a mobile computing device includes a database server (107), an application server (103) to access and handle information stored in the database server, and mobile terminals (101) each connected with the application server by communication channels (115, 113). Each mobile terminal includes an information searching module (305), a link-switching module (303), a data synchronization module (309), a data filter module (307), and a data storage (310). The information searching module further includes a vehicle orders daily searching sub-module (3050), and a distributor orders daily searching sub-module (3052). The link-switching module is for switching states of connection as between the mobile terminal and the application server. The data synchronization module is for downloading information for synchronization from the application server. The data filter module is for filtering modification of data in the data storage, said modification performed when the mobile terminal is disconnected.

### BACKGROUND OF THE INVENTION

1. Field of the Invention

The present invention relates to a system and method for vehicle sales using a mobile computing device, and particularly to a system and a method which provides querying of reports using a mobile computing device.

2. Description of Related Art

By using mobile computing apparatuses, customers can connect with e-mail servers, website servers, online banks and other application apparatuses located in remote database servers of various corporations. Many corporations have realized the potential competitive advantages of connecting their systems and servers via mobile computing apparatuses. These corporations endeavor to extend and enhance performance of tasks and customer relations by providing employees and clients with remote communication user interfaces and systems.

In particular, following the development of portable electronic devices and wireless communications technology, corporations in a variety of commercial fields seek effective information exchange between portable electronic devices of employees or customers and systems or servers of corporations. All involved strive to not only save money, but also to extend and improve their respective competitive advantages.

U.S. Pat. No. 6,125,356 granted on Sep. 26, 2000 and entitled “Portable sales presentation system with selective scripted seller prompts” discloses a handheld computer unit for use by, for example, a car salesperson. The computer unit prompts the salesperson with a standard script to be followed at each step in a sales process once a prospective customer has entered a car dealership.

The above-described portable sales presentation system merely employs a standard script. Said system cannot be used to assist the entire process of selling vehicles through to tasks such as calculating fees applicable to vehicles reserved by a customer. In particular, there is no means for querying of purchase reports by a marketing manager. In addition, the information in the computer unit cannot be updated automatically.

### SUMMARY OF THE INVENTION

An object of the present invention is to provide a system for querying reports using a mobile computing device, in which the system enables a marketing manager to query reports relating to vehicle orders, and in which reports in the mobile computing device can be updated automatically.

Another object of the present invention is to provide a method for querying reports using a mobile computing device, in which the method enables a marketing manager to query reports relating to vehicle orders, and in which reports in the mobile computing device can be updated automatically.

To achieve the first above-mentioned objective, a preferred embodiment of a system of the present invention for querying reports using a mobile computing device comprises an application server, a database server connected with the application server by a network, and a plurality of mobile terminals each connected with the application server by communication channels. Each mobile terminal comprises an information searching module, a link-switching module, a data synchronization module, a data filter module, and a data storage. The data storage is used for storing information on clients, vehicles, employees and budget definitions. The link-switching module is used for switching states of connection as between the mobile terminal and the application server, said states of connection comprising a connected state and a disconnected state. The information searching module comprises a vehicle orders daily searching sub-module and a distributor orders daily searching sub-module, for searching vehicle orders daily information and distributor orders daily information respectively. The data synchronization module is used for downloading information for synchronization from the application server, and for storing the downloaded information in the data storage. The data filter module is used for filtering modification of data stored in the data storage, said modification performed when the mobile terminal is in the disconnected state, and for sending data thus modified to the data synchronization module.

To achieve the second above-mentioned objective, a preferred method of the present invention for querying reports using a mobile computing device comprises the following steps: (a) connecting a mobile terminal with an application server; (b) generating a synchronization request according to a detailed demand input by a user, and sending the synchronization request to the application server; (c) obtaining information needed to meet the synchronization request; (d) setting search parameters, generating a search message, and sending the search message; and (e) generating and displaying search results.

Other objects, advantages and novel features of the present invention will be drawn from the following detailed description of preferred embodiments of the present invention with the attached drawings, in which:

### BRIEF DESCRIPTION OF THE DRAWINGS

FIG. 1 schematically shows hardware infrastructure of a system for querying reports using a mobile computing device in accordance with the preferred embodiment of the present invention;

FIG. 2 schematically shows hardware infrastructure of a system for querying reports using a mobile computing device in accordance with an alternative embodiment of the present invention;

FIG. 3 is a block diagram of software infrastructure of an application server of the system of the present invention;

FIG. 4 is a block diagram of software infrastructure of a PDA (Personal Digital Assistant) of the system of the present invention;

FIG. 5 is a schematic drawing of software infrastructure of an information searching module of the PDA of FIG. 4;

FIG. 6 schematically illustrates an exemplary homepage display on a screen of the PDA of the system of the present invention;

FIG. 7 is similar to FIG. 6, but showing a connection switch icon of the homepage display displayed differently;

FIG. 8 is a flowchart of a preferred method for querying reports using a mobile computing device, in accordance with the present invention; and

FIG. 9 is a flowchart of downloading information from a database server to a PDA, in accordance with one step of FIG. 8 regarding synchronizing information.

### DETAILED DESCRIPTION OF THE INVENTION

Reference will now be made to the drawing figures to describe the present invention in detail.

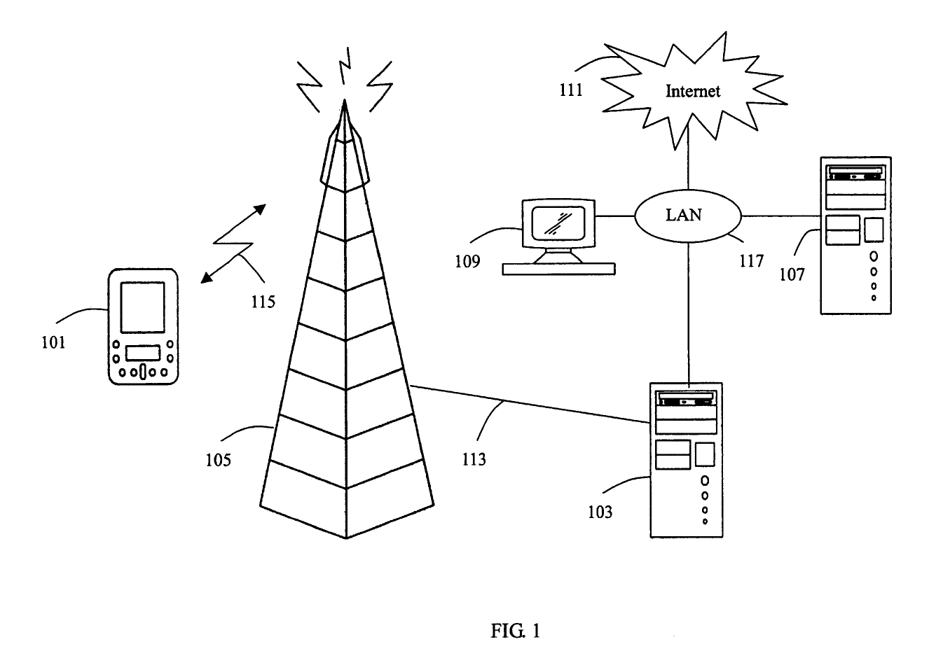

FIG. 1 schematically shows hardware infrastructure of a system for querying reports using a mobile computing device in accordance with the preferred embodiment of the present invention. The system for querying reports is implemented in a corporate information system that comprises a three-level structure: distributed foreground workstations, an application server, and a central database server. In the present invention, each foreground workstation is a mobile computing apparatus such as a PDA (Personal Digital Assistant), a laptop computer, or a smart phone. In the preferred embodiment of the present invention, each mobile computing apparatus is a PDA 101 (only one shown), and users of the PDAs 101 are sellers who process tasks related to selling of vehicles. The application server 103 comprises core and changeable information, and includes programming, operation means, management modules and so on. The application server 103 receives information input from the PDAs 101, processes the information, and returns results to the PDAs 101. A database server 107 manages reading, writing and maintenance of information in an associated database (not shown), and executes updating and searching of information in the database. The database may be located in the database server 107, or may be separate from but connected with the database server 107 via a connection. In the preferred embodiment of the present invention, relevant information includes vehicle information, vehicle delivery information, client information and budget plan information.

A communication tower 105 communicates with each PDA 101 and the application server 103 via a communication channel 115 and a communication channel 113, and transmits inquiry information from the PDA 101 and results information from the application server 103. In the preferred embodiment of the present invention illustrated in FIG. 1, the PDA 101 communicates with the communication tower 105 by using a data machine (not shown). The communication tower 105 connects with the application server 103 via the communication channel 113. The communication channel 113 may be private or public, and may be a hardwired channel or a wireless channel. The application server 103 connects with the database server 107 via a network 117. In the preferred embodiment of the present invention, the network 117 is a LAN (Local Area Network) 117. The LAN 117 connects with a computer terminal 109 for providing means to visit the Internet 111. The PDA 101 also can visit the Internet 111 via the LAN 117, the application server 103, the communication channel 113 and the communication channel 115. In an alternative embodiment of the present invention, the corporate information system may comprise a distributed structure in which there are two or more application servers 103 and two or more database servers 107.

The above-described corporate information system is provided to illustrate the preferred embodiment of the present invention. In alternative embodiments of the present invention, other systems derived from the above-described corporate information system may be used. In addition, other systems may be used to implement the method of the present invention.

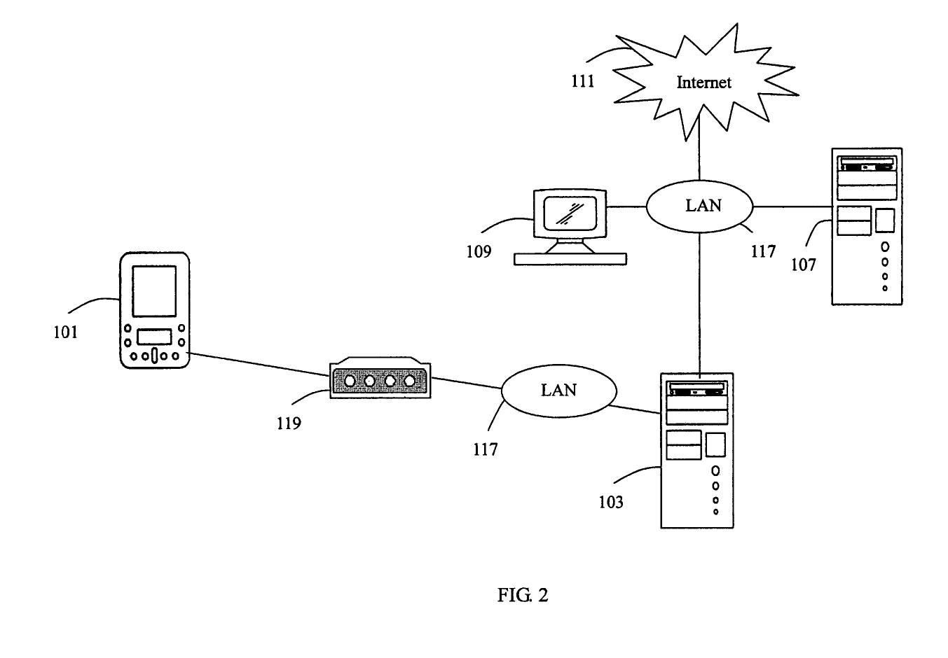

FIG. 2 schematically shows hardware infrastructure of a system for querying reports using a mobile computing device in accordance with an alternative embodiment of the present invention. In this alternative embodiment, the connection between the PDA 101 and the application server 103 is via a hardwired channel. When a user accesses the LAN 117, this connection provides better and more reliable transmission of information. The PDA 101 connects with the LAN 117 via an Ethernet card 119, and connects with the application server 103 and the database server 107 via the LAN 117. In other respects, the hardware infrastructure of the system for querying reports in accordance with the alternative embodiment is similar to that of the preferred embodiment.

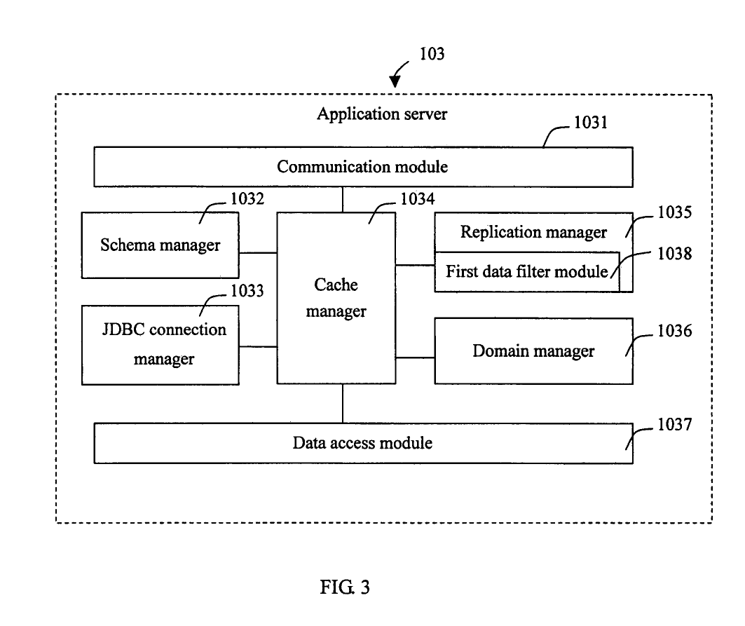

FIG. 3 is a block diagram of software infrastructure of the application server 103. In the preferred embodiment of the present invention, the application server 103 uses a Java Servlet engine structure to set up communication mechanisms for data interchange with the PDA 101 and the database server 107. The application server 103 can also use other structures to communicate with the PDA 101 and the database server 107. The Java servlet corresponds to an applet for extending to website browsing, and is a group of program codes for enhancing a Java application server. A characteristic of Java is that it can extend and connect different background systems more easily. The Java application server can accept a new servlet without modification. Under the structure of the servlet, the system for querying reports needs to download the new servlet once only, on the occasion when the system for querying reports is used for the first time.

In the preferred embodiment of the present invention, the application server 103 comprises: a communication module 1031, a schema manager 1032, a JDBC (Java Database Connectivity) connection manager 1033, a cache manager 1034, a replication manager 1035, a domain manager 1036, and a data access module 1037.

The communication module 1031 is used to communicate with the PDA 101. The application server 103 can receive information sent by the PDA 101 (such as requirement information), and transmit relevant feedback information to the PDA 101 by using the communication module 1031.

The cache manager 1034 is used to provide cache information as required in accordance with LRU (Least Recently Used) logic, and to receive relevant feedback information sent by the PDA 101 and the database server 107.

The JDBC connection manager 1033 can preset a JDBC connection, and manage the connection with the database server 107. Such management comprises obtaining an immediate connection, obtaining a connection delayed, and cutting all connections upon shutdown. Management may also comprise processing failures of connection and communication.

The replication manager 1035 is used to control mutual updating tasks of the PDA 101 and the database server 107, and to detect and arbitrate conflicting information sent by different users from their respective PDAs 101. The replication manager 1035 comprises a first data filter module 1038. The first data filter module 1038 is used to filter information added in the database server 107, or modify existing information in the database server 107 and the PDA 101.

In the preferred embodiment of the present invention, the schema manager 1032 provides two kinds of information schema. That is, a main database schema and a PDA schema, both of which are provided in XML format. The main database schema describes the relationship between the information schema and tables in the database server 107, and the PDA schema simplifies information demanded by different PDAs 101. The schema manager 1032 selects information from the database server 107, applies the information schema, and transmits resulting information to a relevant PDA 101.

The domain manager 1036 is used to manage domains. In the preferred embodiment of the present invention, the information in the database server 107 is structured as a group of domains. A particular domain contains the definition of a particular object, including the individual data elements, or “attributes,” that make up the object. Each attribute has a data type and one or more values. For example, an “account” object may include attributes related to a bank account such as the owner's name, the balance and tax rate information. The type of account balance may be decimal, and a value of the account balance may be 100.00; that is, one hundred dollars. Each of information selectors of the first data filter module 1038 corresponds to one or more domains.

The data access module 1037 is used to communicate with the database server 107, and obtain information from domains via the first data filter module 1038. The data access module 1037 can automatically obtain relevant information and filter information using a data filter, which makes it easier to obtain information.

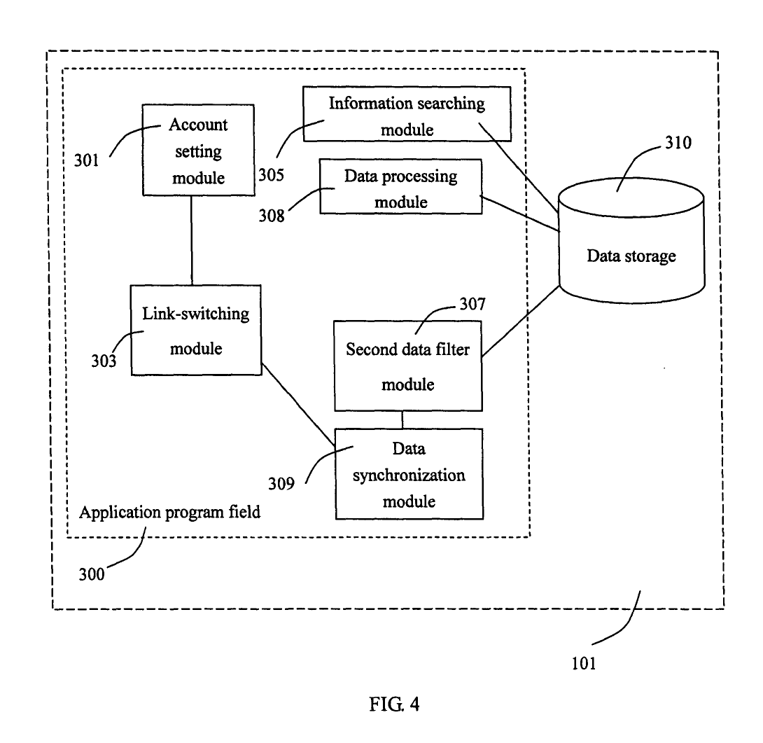

FIG. 4 is a block diagram of software infrastructure of the PDA 101 in accordance with the present invention. The PDA 101 comprises an application program field 300 and a data storage 310. The application program field 300 is used to perform the functions of the PDA 101. The data storage 310 is used to store local information, such as information on clients, vehicles, sellers and budget plans. The application program field 300 comprises an account setting module 301, a link-switching module 303, an information searching module 305, a second data filter module 307, a data processing module 308, and a data synchronization module 309.

The data processing module 308 and the information searching module 305 are both used to process data stored in the data storage 310. The second data filter module 307 and the data synchronization module 309 are used to synchronize data of the PDA 101 and the database server 107.

The account setting module 301 is used to set dial-up accounts for connections in regions which the user of the PDA 101 routinely visits. When the user goes to these regions, he/she can use the local dial-up accounts to save on communication costs.

The link-switching module 303 is used to receive connecting or disconnecting orders sent by the user of the PDA 101, and to switch connection between the PDA 101 and the application server 103. In the preferred embodiment of the present invention, there are two states of connection of the PDA 101 with the application server 103; that is, a disconnected state and a connected state. The disconnected state means that the PDA 101 cannot communicate with the application server 103 as there is no effective communication channel set up between them. The connected state means that the PDA 101 can communicate with the application server 103 as there is an effective communication channel set up between them.

The data processing module 308 is used to update and add to data stored in the data storage 310. A user can update or add to data only after being authorized to do so.

The information searching module 305 is used to send requirements to the application server 103 for searching of data stored in the database server 107, and to search data in the data storage 310 of the PDA 101.

The data synchronization module 309 can generate a synchronization requirement, which is used to attain data synchronization between the PDA 101 and the database server 107. The requirement comprises two types of operations: downloading of data, and uploading of data. The requirement can be sent to the communication module 1031 of the application server 103.

The second data filter module 307 is used to filter data stored in the data storage 310 of the PDA 101 which was modified when the PDA 101 was disconnected from the database server 107, and to send the modified data to the database server 107 for synchronizing with data in the database server 107 when the PDA 101 is next connected with the database server 107. The data synchronization module 309 synchronizes the data filtered by the second data filter module 307 with the data in the database server 107 when the PDA 101 is connected. The second data filter module 307 can also download data from the database server 107 when the PDA 101 is connected.

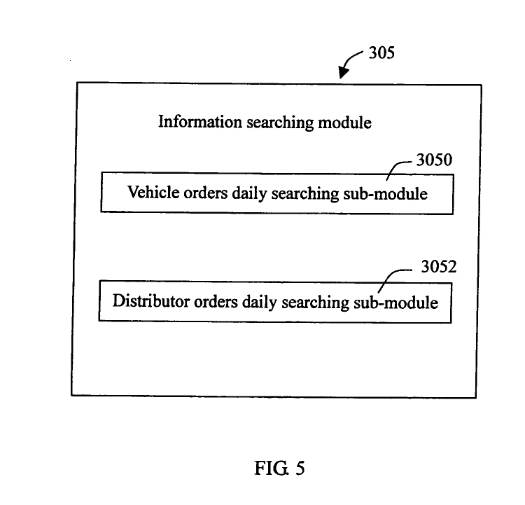

FIG. 5 is a schematic drawing of software infrastructure of the information searching module 305 of the PDA 101. The information searching module 305 comprises a vehicle orders daily searching sub-module 3050, and a distributor orders daily searching sub-module 3052. The vehicle searching sub-module 3050 comprises fields of day orders, month orders and day stocks of all types of vehicles. The distributor orders daily searching sub-module 3052 comprises fields of day orders, month orders, day stocks, and orders of each type of vehicle of each distributor. When a user clicks on a distributor, an interface with the detailed orders and stocks information of the vehicles of all stores of the distributor is displayed. Both the vehicle and the distributor searching sub-modules 3050, 3052 provide selectable search parameters such as date, order, sale, returned order and all types of vehicles with date for users to search relevant information. Said information is stored in the data storage 310 of the PDA 101, and the information in the data storage 310 can be synchronized with the relevant information stored in the database server 107.

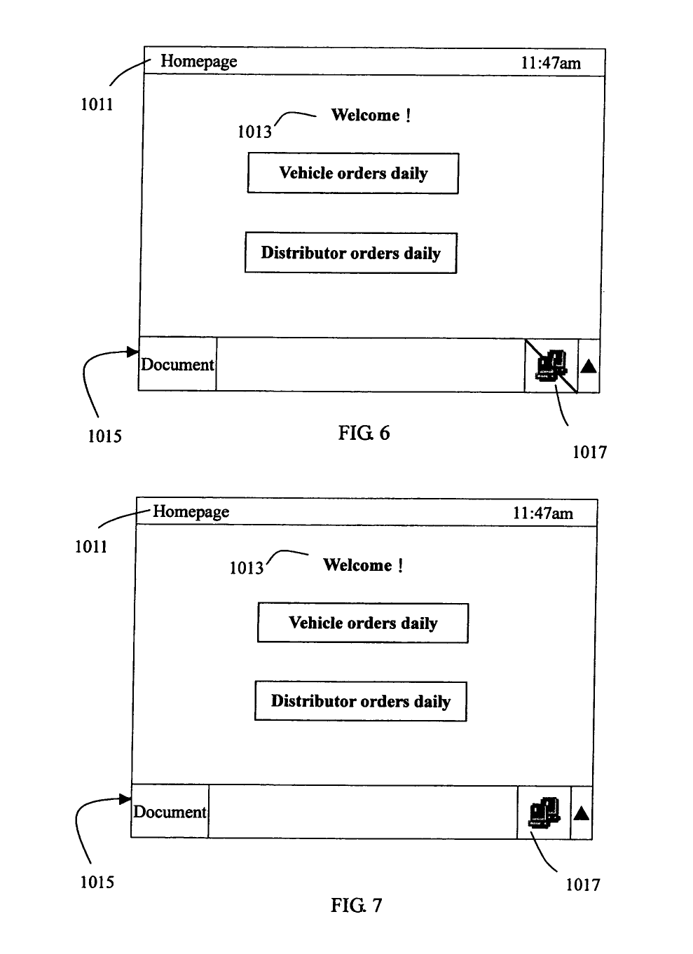

FIGS. 6 and 7 schematically illustrate exemplary homepage displays on the PDA 101, in accordance with the present invention. When a user switches on the PDA 101, the homepage is displayed on a display screen of the PDA 101. On the top of the homepage, there is a title field 1011 that comprises a title “homepage” and a current time “11:47 am.” Under the title field 1011, there is a “Welcome!” message 1013. The message 1013 is preset; and may alternatively be, for example, “Welcome to the system of XX COMPANY!” Under the message 1013, there are two screen icons; namely a vehicle orders daily icon, and a distributor orders daily icon. The user can search the information on orders of vehicles stored in the data storage 310 via the vehicle orders daily icon. The user can search the information on orders of a distributor stored in the data storage 310 via the distributor orders daily icon. Under the screen icons, there is a menu bar 1015 that comprises a “document” key, which enables the user to perform tasks such as opening documents, closing documents and storing documents. Most notably, the menu bar 1015 further comprises a connection switch icon 1017, for indicating the state of connection between the PDA 101 and the application server 103. When the PDA 101 is in the disconnected state, a red slash is displayed across the connection switch icon 1017 (as shown in FIG. 6). In the disconnected state, the PDA 101 cannot communicate with the database server 107, but can manage data in the data storage 310. When the PDA 101 is in the connected state, the red slash is not displayed on the connection switch icon 1017 (as shown in FIG. 7). In the connected state, the PDA 101 can communicate with the database server 107 to download data from the database server 107 and upload data to the database server 107.

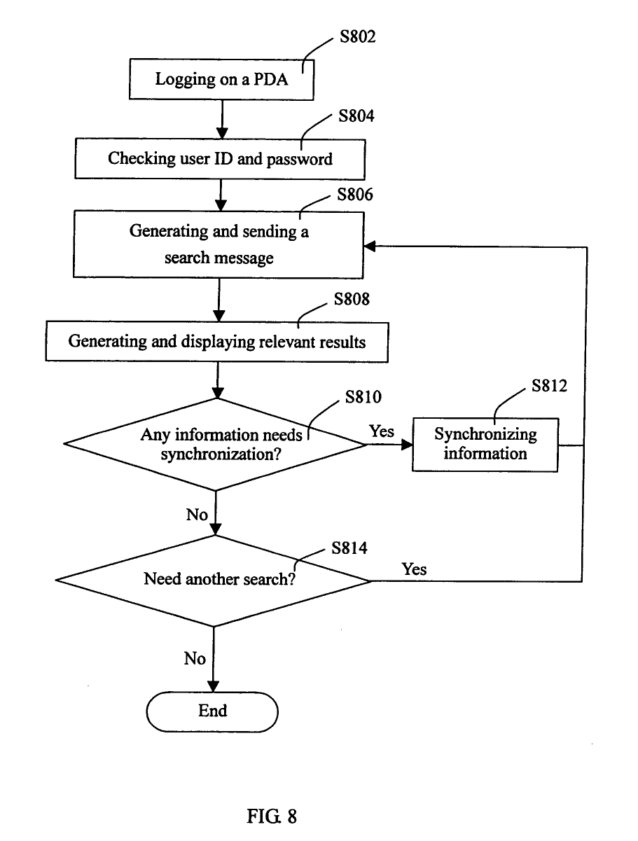

FIG. 8 is a flowchart of a preferred method for querying reports using a mobile computing device, in accordance with the present invention. In step S802, a user provides an ID and a password for logging on the PDA 101. This helps prevent unauthorized persons from using the PDA 101. If several successive unsuccessful attempts to log on are performed, the PDA 101 automatically deletes information stored in the data storage 310 thereof. In step S804, the PDA 101 checks said ID and password. In step S806, if the log on is successful, the information searching module 305 prompts the user to set search parameters, generates a search message and sends the search message to the data storage 310. In step S808, the PDA 101 generates and displays relevant results on its screen. In step S810, the PDA 101 prompts the user to decide whether he/she has information needing to be synchronized with that in the database server 107. Such information typically comprises client information, vehicle information, vehicle orders information, and distributor orders information. If information needs to be synchronized, in step S812, the user connects the PDA 101 with the database server 107, and downloads updating information from the database server 107. The procedure then returns to step S806. If and when no information needs to be synchronized, in step S814, the user decides whether he/she needs another search. If another search is needed, the procedure returns to step S806. If another search is not needed, the procedure is ended.

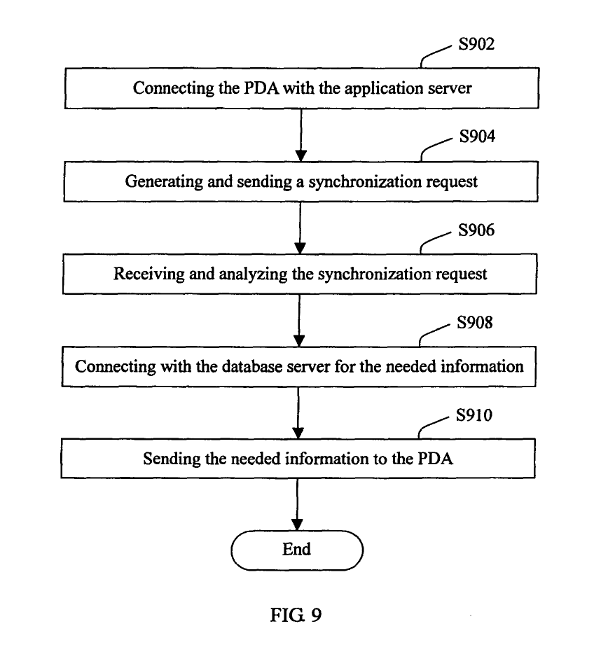

FIG. 9 is a flowchart of downloading information from the database server 107 to the PDA 101, in accordance with step S812 of FIG. 8 regarding synchronizing information. In step S902, the link-switching module 303 connects the PDA 101 with the application server 103. In step S904, the data synchronization module 309 of the PDA 101 generates a synchronization request according to a detailed demand input by the user, and sends the synchronization request to the application server 103. In step S906, the communication module 1031 of the application server 103 receives the synchronization request, and stores the synchronization request in the cache manager 1034. The first data filter module 1038 of the replication manager 1035 analyzes the synchronization request, and the domain manager 1036 determines the domain of the synchronization request. In step S908, the data access module 1037 connects with the database server 107, to obtain information needed to meet the synchronization request based on the results of analysis by the first data filter module 1038. In step S910, the application server 103 stores the needed information in the cache manager 1034, and sends the needed information to the PDA 101 via the communication module 1031. It is to be noted that a procedure of uploading information from the PDA 101 to the database server 107 is similar to the above-described procedure for downloading of information, with due alteration of details.

In general, the system and method for querying reports of the present invention may take forms other than what is described above. While preferred embodiments for carrying out the invention have been described in detail, those familiar with the art to which the invention relates will recognize various alternative designs and embodiments for practicing the invention. These alternative embodiments are within the scope of the present invention. The scope of the present invention is defined by the claims appended hereto and allowable equivalents thereof.

What is claimed is:

1. A system for querying reports using a mobile computing device, the system comprising an application server, a database server connected with the application server by a network, and a plurality of mobile terminals connected with the application server by a communication channel, wherein:
the application server comprises a cache manager and a replication manager, wherein:
the cache manager is used to receive and store information sent by the mobile terminals and the database server; and
the replication manager comprises a first data filter module, which is used to filter information added in the database server, and to modify existing information in the database server and the mobile terminals;
each of the mobile terminals comprises an information searching module, the information searching module further comprises a vehicle orders daily searching sub-module and a distributor orders daily searching sub-module for searching vehicle orders daily information and distributor orders daily information respectively; and
the database server is used for storing information on clients, vehicles and distributor orders.

2. The system for querying reports using a mobile computing device as described in claim 1, wherein each of the mobile terminals further comprises a data storage for storing information downloaded from the application server and input from the mobile terminals.

3. The system for querying reports using a mobile computing device as described in claim 1, wherein each of the mobile terminals further comprises a link-switching module for switching states of connection as between the mobile terminal and the application server, said states of connection comprising a connected state and a disconnected state.

4. The system for querying reports using a mobile computing device as described in claim 1, wherein each of the mobile terminals further comprises a data synchronization module for downloading information for synchronization from the application server, and for storing the downloaded information in the data storage.

5. The system for querying reports using a mobile computing device as described in claim 1, wherein each of the mobile terminals further comprises a second data filter module for filtering modification of data stored in the data storage, said modification performed when the mobile terminal is in the disconnected state, and for sending data thus modified to the data synchronization module.

6. The system for querying reports using a mobile computing device as described in claim 1, wherein each of the mobile terminals can be a personal digital assistant, a laptop computer, or a smart phone.

7. The system for querying reports using a mobile computing device as described in claim 1, wherein each of the mobile terminals further comprises an account setting module for setting dial-up accounts for connections in regions which a user of the mobile terminal routinely visits.

8. The system for querying reports using a mobile computing device as described in claim 1, wherein the application server further comprises a domain manager for managing domains.

9. A method for querying reports using a mobile terminal, the method comprising the following steps:
(a) connecting the mobile terminal with an application server;
(b) generating a synchronization request according to a detailed demand input by a user, and sending the synchronization request to the application server;
(c) obtaining information needed to meet the synchronization request;
(d) setting one or more search parameters, generating a search message, and sending the searching message; and
(e) generating and displaying search results.

10. The method for querying reports using a mobile terminal as described in claim 9, wherein said information comprises information on any one or more of clients, vehicles and distributor orders.

11. The method for querying reports using a mobile terminal as described in claim 9, further comprising the step of:
cutting off the connection between the mobile terminal and the application server.

12. A system for querying reports using a mobile computing device, the system comprising an application server, a database server connected with the application server by a network, and a plurality of mobile terminals connected with the application server by a communication channel, wherein:
the application server comprises a cache manager and a replication manager, wherein:
the cache manager is used to receive and store information sent by the mobile terminals and the database server; and
the replication manager comprises a first data filter module, which is used to filter information added in the database server, and to modify existing information in the database server and the mobile terminals;
each of the mobile terminals comprises an information searching module, the information searching module further comprises a vehicle orders daily searching sub-module for searching vehicle orders daily information; and
the database server is used for storing information on clients, vehicles and distributor orders.
